(19) United States
(12) Patent Application Publication
(10) Pub. No.: US 2025/0370691 A1
(43) Pub. Date: Dec. 4, 2025

(54) DUAL-SCREEN MOBILE APPARATUS AND CONTROL METHOD FOR DUAL-SCREEN MOBILE APPARATUS

(71) Applicant: COMPAL ELECTRONICS, INC., Taipei City (TW)

(72) Inventors: Ching Lin, Taipei City (TW); Hui-Wen Chan, Taipei City (TW)

(73) Assignee: COMPAL ELECTRONICS, INC., Taipei City (TW)

(21) Appl. No.: 19/220,095

(22) Filed: May 28, 2025

Related U.S. Application Data
(60) Provisional application No. 63/652,644, filed on May 28, 2024.

(51) Int. Cl. G06F 3/14; G06F 1/16; G06F 3/0482; G06F 3/04883

(52) U.S. Cl. CPC G06F 3/1423; G06F 1/1624; G06F 1/1647; G06F 3/0482; G06F 3/04883; G06F 2203/04803

(57) ABSTRACT

A dual-screen mobile apparatus and a control method for the dual-screen mobile apparatus are provided. The dual-screen mobile apparatus includes a first body, a second body, a first display, a second display, a movable mechanism, one or more sensors, and a processor. The movable mechanism movably connects the first body and the second body and is configured to translate and slide the first body or the second body. The sensor detects the relative position between the first display and the second display. The processor is configured to generate prompt information according to the relative position between the first display and the second display and a content of the first display, input the prompt information into a neural network model, obtain derivative information corresponding to the prompt information output by the neural network model, and generate a display content of the second display according to the derivative information.

### CROSS-REFERENCE TO RELATED APPLICATION

This application claims the priority benefit of U.S. Provisional Application No. 63/652,644, filed on May 28, 2024. The entirety of the above-mentioned patent application is hereby incorporated by reference herein and made a part of this specification.

### BACKGROUND

### Technical Field

The disclosure relates to a multi-display screen control technology, and more particularly to a dual-screen mobile apparatus and a control method for the dual-screen mobile apparatus.

### Description of Related Art

Current electronic reading apparatuses cannot actively provide users with activity suggestions when processing various information formats and analysis results of artificial intelligence (AI). In addition, existing apparatuses often lack sufficient screen space when users need to simultaneously display auxiliary information such as translations, related information, summaries, or notes generated by artificial intelligence.

### SUMMARY

The disclosure provides a dual-screen mobile apparatus and a control method for the dual-screen mobile apparatus, which has sufficient screen space to provide appropriate activity suggestions.

A dual-screen mobile apparatus of the embodiment of the disclosure includes (but is not limited to) a first body, a first display, a second body, a second display, a movable mechanism, one or more sensors, and a processor. The first display is disposed on the first body. The second display is disposed on the second body. A normal direction of a panel of the second display is the same as a normal direction of a panel of the first display. The movable mechanism movably connects the first body and the second body and is configured to translate and slide at least one of the first body and the second body. The one or more sensors are disposed on at least one of the first body and the second body and are configured to detect a relative position between the first display and the second display. The processor is coupled to the first display, the second display, and the one or more sensors. The processor generates prompt information according to the relative position between the first display and the second display and a content of the first display, inputs the prompt information into a neural network model, obtains derivative information corresponding to the prompt information output by the neural network model, and generates a display content of the second display according to the derivative information.

A control method for a dual-screen mobile apparatus according to an embodiment of the disclosure includes (but is not limited to) the following steps. A first display, a second display, a movable mechanism, at least one sensor, and a processor are provided. The first display is disposed on the first body, the second display is disposed on the second body, a normal direction of a panel of the second display is the same as a normal direction of a panel of the first display, the movable mechanism movably connects the first body and the second body and is configured to translate and slide at least one of the first body and the second body, and the at least one sensor is configured to detect a relative position between the first display and the second display. Prompt information is generated according to the relative position between the first display and the second display and a content of the first display. The prompt information is input into a neural network model, and derivative information corresponding to the prompt information output by the neural network model is obtained. A display content of the second display is generated according to the derivative information.

Based on the above, in the dual-screen mobile apparatus and the control method for the dual-screen mobile apparatus according to the embodiments of the disclosure, the state of the apparatus is changed using the slidable movable mechanism, the relative position of the dual screens is detected through the sensor, and the display content of the second screen is intelligently generated according to the content of the first screen and the relative position of the dual screens through the neural network model. In this way, the interactive experience of the user and information acquisition efficiency can be improved.

In order for the features and advantages of the disclosure to be more comprehensible, the following specific embodiments are described in detail in conjunction with the drawings.

### BRIEF DESCRIPTION OF THE DRAWINGS

FIG. 1 is a block diagram of elements of a dual-screen mobile apparatus according to an embodiment of the disclosure.

FIG. 2 is a schematic diagram of a dual-screen mobile apparatus according to an embodiment of the disclosure.

FIG. 3 is a flowchart of a control method according to an embodiment of the disclosure.

FIG. 4A is a schematic diagram of usage state detection according to an embodiment of the disclosure.

FIG. 4B is a schematic diagram of usage state detection according to another embodiment of the disclosure.

FIG. 5A is a schematic diagram of an itinerary arrangement scenario according to an embodiment of the disclosure.

FIG. 5B is a schematic diagram of handwritten information according to an embodiment of the disclosure.

FIG. 6A is a flowchart of conference arrangement according to an embodiment of the disclosure.

FIG. 6B is a flowchart of auxiliary prompting according to an embodiment of the disclosure.

FIG. 6C is a flowchart of itinerary conflict management according to an embodiment of the disclosure.

FIG. 6D is a flowchart of occupancy conflict management according to an embodiment of the disclosure.

FIG. 7 is a flowchart of translation according to an embodiment of the disclosure.

FIG. 8 is a schematic diagram of a translation scenario according to an embodiment of the disclosure.

FIG. 9 is a flowchart of activity suggestion according to an embodiment of the disclosure.

FIG. 10 is a schematic diagram of a note-taking scenario according to an embodiment of the disclosure.

FIG. 11 is a flowchart of article compilation according to an embodiment of the disclosure.

FIG. 12 is a schematic diagram of an article compilation scenario according to an embodiment of the disclosure.

FIG. 13 is a flowchart of information integration according to an embodiment of the disclosure.

FIG. 14 is a schematic diagram of an information integration scenario according to an embodiment of the disclosure.

FIG. 15 is a schematic diagram of input conversion and template application according to an embodiment of the disclosure.

### DESCRIPTION OF THE EMBODIMENTS

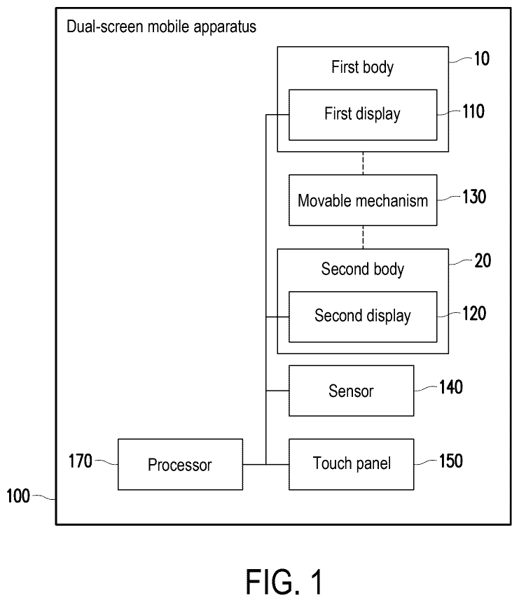

FIG. 1 is a block diagram of elements of a dual-screen mobile apparatus 100 according to an embodiment of the disclosure. Please refer to FIG. 1. The dual-screen mobile apparatus 100 may be a smart phone, a tablet computer, a notebook computer, an e-reader, or other electronic apparatuses.

The dual-screen mobile apparatus 100 includes (but is not limited to) a first body 10, a second body 20, a first display 110, a second display 120, a movable mechanism 130, one or more sensors 140, a touch panel 150, and a processor 170.

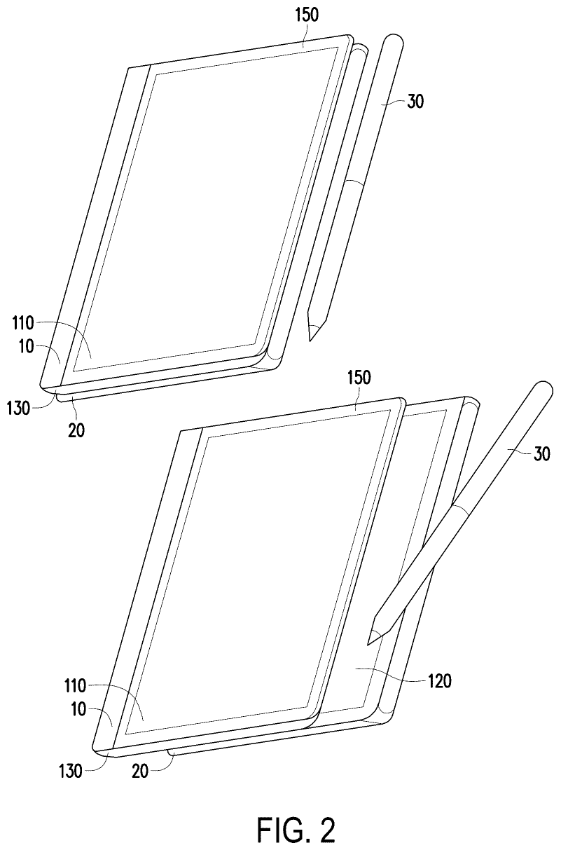

FIG. 2 is a schematic diagram of a dual-screen mobile apparatus according to an embodiment of the disclosure. Please refer to FIG. 2. The first display 110 is disposed on a surface of the first body 10. The second display 120 is disposed on a surface of the second body 10. The sizes of the first body 10 and the second body 20 are roughly the same, but may still be adjusted according to design requirements. As shown in the three-dimensional figure at the bottom of FIG. 2, the normal direction of a panel (also referred to as a screen) of the second display 120 is the same as the normal direction of a panel of the first display 110. In this way, a user may simultaneously see two panels (as shown in an expanded scenario of the three-dimensional figure at the bottom).

The first display 110 and the second display 120 may be liquid crystal displays (LCDs), light emitting diode (LED) displays, organic light emitting diode (OLED) displays, or electronic paper displays.

The movable mechanism 130 may movably connect the first body 10 and the second body 20 and is configured to translate and slide the first body 10 or the second body 20. Taking FIG. 2 as an example, in a closed scenario of the three-dimensional figure on the left, the first body 10 completely covers a surface of the second body 10. The panel of the second display 20 is completely covered by the first body 10. At this time, the user cannot see the content displayed on the second display 120, but may see the content displayed on the first display 110. The movable mechanism 130 includes, for example, a slide rail, a guide rail, and/or a slider (which may be integrated into the first body 10 or the second body 20 or may be an independent element). When an external force is applied to the first body 10 and/or the second body 20, the first body 10 may translate and slide relative to the second body 20. That is, a relative position between the first body 10 and the second body 20 is changed, and a relative position between the first display 110 and the second display is changed. Compared to the three-dimensional figure at the top of FIG. 2, a side (the right side as shown in the figure) of the first body 10 shown in the three-dimensional figure at the bottom is away from a side (the right side as shown in the figure) of the second body 20. The panel of the second display 20 is partially covered by the first body 10. At this time, the user may see the contents displayed on the first display 110 and the second display 120.

It should be noted that the mechanisms and the operation methods for translation and sliding are not limited to as shown in FIG. 2.

In an embodiment, the sensor 140 is a switch. For example, a micro switch may trigger switching of an internal circuit thereof by an external force. In a non-loaded (also referred to as non-triggered) state, a closed circuit is formed. In a loaded (also referred to as triggered) state, an open circuit is formed. When the first body 10 and/or the second body 20 change positions, one or more switches may be in the loaded state or may also be in the non-loaded state. That is, the first body 10 and/or the second body 20 may apply forces to one or more switches at a specific position. Therefore, based on the positions of the switches, the relative position between the first body 10 and/or the second body 20 can be known.

In another embodiment, the sensor 140 is a distance sensor, such as an infrared sensor, a Hall effect sensor, or a capacitive sensor. The distance sensor is configured to detect distance information. The distance information indicates, for example, a distance value of a side (the right side as shown in FIG. 2) of the first body 10/the first display 110 relative to a side (the right side as shown in FIG. 2) of the second body 20/the second display 120.

The touch panel 150 may be a capacitive, resistive, infrared, or surface acoustic wave touch panel. In an embodiment, the touch panel 150 is configured to receive a user operation and receive handwritten information accordingly. The user operation is a stylus 30, a hand, or other input tools as shown in FIG. 2 moving while contacting the touch panel 150 or close to the touch panel 150. The handwritten information is the position, path, and/or text information corresponding to a movement trajectory under the user operation.

The processor 170 is coupled to the first display 110, the second display 120, one or more sensors 140, and the touch panel 150. The processor 170 may be a central processing unit (CPU), a graphics processing unit (GPU), a data processing unit (DPU), a visual processing unit (VPU), a tensor processing unit (DPU), a neural network processing unit (NPU), other programmable general-purpose or specific-purpose microprocessors, digital signal processors (DSPs), programmable controllers, field programmable gate arrays (FPGAs), application-specific integrated circuits (ASICs), other similar elements, or a combination of the above elements. In an embodiment, the processor 170 is configured to execute all or a part of the operations of the dual-screen mobile apparatus 100 and may load and execute one or more software modules, files, and/or data stored in a memory (not shown), thereby executing one or more methods of the embodiments of the disclosure.

In some embodiments, the dual-screen mobile apparatus 100 may further include a communication transceiver (not shown), such as a communication transceiving circuit/transmission interface supporting Bluetooth, Wi-Fi, mobile network, optical fiber network, universal serial bus (USB), thunderbolt, or other communication technologies. In an embodiment, the communication transceiver is configured to receive data from other apparatuses or transmit data to other apparatuses, such as connecting to an artificial intelligence processor or a cloud server.

Hereinafter, the method described in the embodiment of the disclosure will be illustrated with reference to the apparatuses, the elements, and the modules in FIG. 1 and FIG. 2. Each process of the method may be adjusted according to the implementation situation and is not limited thereto.

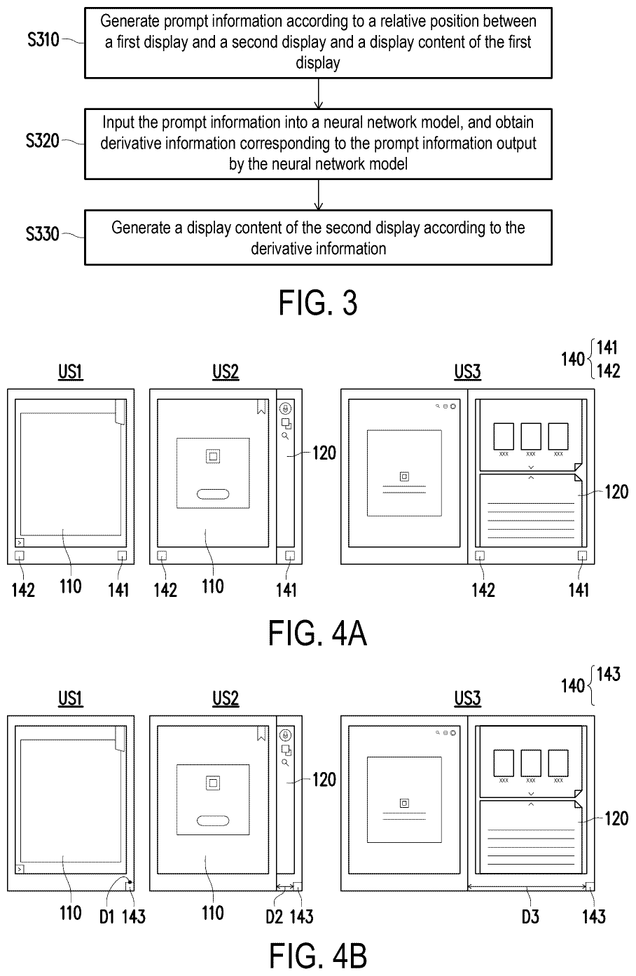

FIG. 3 is a flowchart of a control method according to an embodiment of the disclosure. Please refer to FIG. 3. The processor 170 generates prompt information according to the relative position between the first display 110 and the second display 120 and the display content of the first display 110 (step S310). Specifically, as described above with respect to the movable mechanism 130, the first display 110 and the second display 120 may relatively translate and slide, so as to change the relative position between the first display 110 and the second display 120.

In an embodiment, multiple relative positions between the first body 10/the first display 110 and the second body 20/the second display 120 respectively correspond to multiple usage states.

FIG. 4A is a schematic diagram of usage state detection according to an embodiment of the disclosure. Please refer to FIG. 4A. The sensor 140 includes a first switch 141 and a second switch 142. For example, the first switch 141 is disposed at the bottom right corner of the first display 110 (such as being located on a back surface of the first body 10), and the second switch 142 is disposed at the bottom left corner of the first display 110 (such as being located on a back surface of the first body 10).

When the first switch 141 and the second switch 142 are both triggered, the processor 170 may determine that the relative position (for example, a closed position) between the first display 110 and the second display 120 corresponds to a first usage state US1, and the panel of the second display 120 is completely covered by the first body 10. At this time, the first switch 141 and the second switch 142 are both triggered (also referred to as being in the loaded state) by the force applied by the second body 20 or the second display 120.

When one of the first switch 141 and the second switch 142 is triggered but the other one of the first switch 141 and the second switch 142 is not triggered, the processor 170 may determine that the relative position (for example, a half-open position) between the first display 110 and the second display 120 corresponds to a second usage state US2. At this time, the panel of the second display 120 is partially covered by the first body 10. That is, a part of the panel of the second display 120 is exposed. As shown in the figure, the second switch 142 is triggered (also referred to as being in the loaded state) by the force applied by the second body 20 or the second display 120, but the first switch 141 is not triggered (also referred to as being in the non-loaded state) by the force applied by the second body 20 or the second display 120. Compared to the first usage state US1, a side (the right side as shown in the figure) of the first display 110 in the second usage state US2 is away from a side (the right side as shown in the figure) of the second display 120.

When the first switch 141 and the second switch 142 are both not triggered, the processor 170 may determine that the relative position (for example, a fully-open position) between the first display 110 and the second display 120 corresponds to a third usage state US3, and the panel of the second display 120 is completely not covered by the first body 10. At this time, the first switch 141 and the second switch 142 are both not applied with the force from the second body 20 or the second display 120 and are not triggered (also referred to as being in the non-loaded state).

FIG. 4B is a schematic diagram of usage state detection according to another embodiment of the disclosure. Please refer to FIG. 4B. The sensor 140 includes a distance sensor 143. For example, the distance sensor 143 is disposed at the bottom right corner of the second display 120 (such as being located on a front surface of the second body 10). The distance sensor 143 is configured to detect distance information between the first body 10 and the second body 20. The distance information indicates a distance value between a first reference position located on the first body 10 (for example, a point on the right side as shown in the figure) and a second reference position located on the second body 20 (for example, the position of the distance sensor 143 or a point on the right side as shown in the figure).

When the distance sensor 143 detects first distance information D1, the processor 170 may determine that the relative position (for example, the closed position) between the first display 110 and the second display 120 corresponds to the first usage state US1, and the panel of the second display 120 is completely covered by the first body 10. The first distance information D1 indicates that the distance value between the first reference position located on the first body 10 and the second reference position located on the second body 20 is zero or a value less than a lower limit value (for example, 1 cm or 8 mm) (but greater than zero).

When the distance sensor 143 detects second distance information D2, the processor 170 may determine that the relative position (for example, the half-open position) between the first display 110 and the second display 120 corresponds to the second usage state US2, and the panel of the second display 120 is partially covered by the first body 10. The distance value indicated by the second distance information D2 is greater than the distance value indicated by the first distance information D1. For example, the distance value indicated by the second distance information D2 is between 1 cm and m cm, where m is a lateral width of the second body 20 or the second display 120 (an error value may be taken into account).

When the distance sensor 143 detects third distance information D3, the processor 170 may determine that the relative position (for example, the fully-open position) between the first display 110 and the second display 120 corresponds to the third usage state US3, and the panel of the second display 120 is completely not covered by the first body 10. The distance value indicated by the third distance information D3 is greater than the distance value indicated by the second distance information D2. For example, the distance value indicated by the third distance information D3 is m cm, where m is the lateral width of the second body 20 or the second display 120 (an error value may be taken into account).

In an embodiment, the identification code of the usage state (for example, the first usage state US1, the second usage state US2, and the third usage state US3 shown in FIG. 4A and FIG. 4B), the distance value between the first body 10/the first display 110 and the second body 20/the second display 120, the loading state and/or the coordinate value of the switch may be configured to indicate the relative position between the first display 110 and the second display 120 and serve as the prompt information accordingly.

It should be noted that the technology for detecting and determining the relative position between the first display 110 and the second display 120 is not limited to the above description, and the user may adjust the technological means according to actual requirements.

On the other hand, the processor 170 may capture the display content of the first display 110 (and/or the second display 120), such as capturing a screen/taking a screenshot through a screenshot function/process.

In an embodiment, the processor 170 may convert the captured display content into an image. The image may serve as the prompt information.

In an embodiment, processor 170 may convert the captured display content into a text content. For example, text in the image is converted into a computer-editable text format through optical character recognition (OCR). For another example, handwriting is converted into a computer-editable text format through handwritten text recognition (HTR). The content of the text format (that is, a text content) may serve as the prompt information.

In an embodiment, the processor 170 may integrate position information corresponding to the relative position between the first display 110 and the second display 120 (for example, the identification code of the usage state, the distance value between the first body 10/the first display 110 and the second body 20/the second display 120, the loading state and/or the coordinate value of the switch) and the display content of the first display 110 (for example, the image or the text content) into the prompt information. The prompt information is content for indicating association conditions of derivative information output by a neural network model, such as “the apparatus is in the first usage state US1, the image content is an article, and the article content is . . . ” or “the apparatus is in the second usage state US2, the image content is handwritten information, and the handwritten information is . . . ”.

Please refer to FIG. 3. The processor 170 inputs the prompt information into the neural network model, and obtains the derivative information corresponding to the prompt information output by the neural network model (step S320). Specifically, the neural network model is, for example, a convolutional neural network (CNN), a recurrent neural network (RNN), a transformer network, a large language model (LLM), or a generative artificial intelligence model. In an embodiment, the processor 170 runs the neural network model standalone/offline. In another embodiment, an external apparatus (for example, a cloud server) runs the neural network model. For example, the processor 170 transmits the prompt information to the cloud server through the communication transceiver. The cloud server uses the neural network model to generate the derivative information corresponding to the prompt information.

The neural network model is trained on a data set and learns to map input data (for example, the image content and the relative position between the first display 110 and the second display 120) to the corresponding derivative information, thereby establishing a relationship between the input data and output information of the neural network model. The input data is, for example, the prompt information in the image and/or text format (for example, the content for specifying the association conditions of the output derivative information). The data set is the known relative position (for example, the relative position between the first display 110 and the second display 120), the display content (for example, screenshot images of the first display 110 and/or the second display 120), and tagged application information (for example, the type of the derivative information and a conversion content for integrating the display content into the corresponding type). The neural network model may be trained on a large data set to learn to predict the likelihood of the next word or symbol in a sequence. After training, the neural network model can receive input data (for example, an image, the beginning of one or more sentences, one or more questions, one or more descriptions), and gradually generate a subsequent text content (for example, derivative information) according to learnt language rules.

The derivative information is, for example, related to conference arrangement, itinerary arrangement, translation, information compilation, activity, or information integration, but not limited thereto.

The processor 170 may generate the display content of the second display 120 according to the derivative information (step S330). Specifically, the text content of the derivative information may be presented on the second display 120. However, the layout and the style of the display content on the second display may vary depending on the type and/or the content of the derivative information.

Application scenarios are illustrated below.

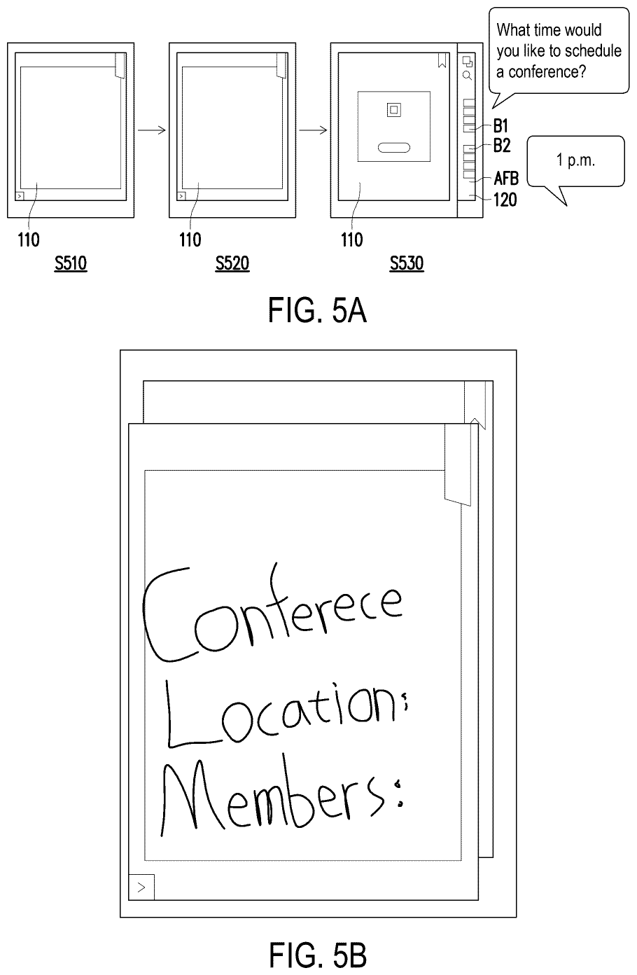

FIG. 5A is a schematic diagram of an itinerary arrangement scenario according to an embodiment of the disclosure. Please refer to FIG. 5A. In the first usage state US1 as shown in FIG. 4A or FIG. 4B, the first display 110 displays an interface of a handwritten note function (for example, an interface of a notebook program) (step S510). The interface may receive a touch operation of the user through the touch panel 150, and receive the corresponding handwritten information accordingly (step S520). The handwritten information corresponds to a position of one or more trajectory points and/or a path formed based on one or more trajectory points. For example, FIG. 5B is a schematic diagram of handwritten information according to an embodiment of the disclosure. Please refer to FIG. 5B. The user writes down “conference time . . . ”, “location . . . ”, and “members . . . ”.

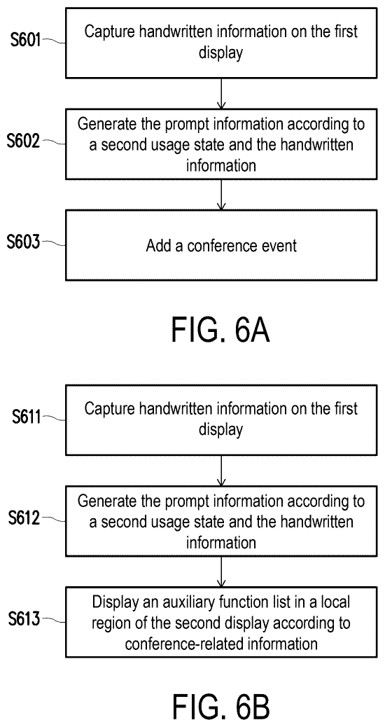

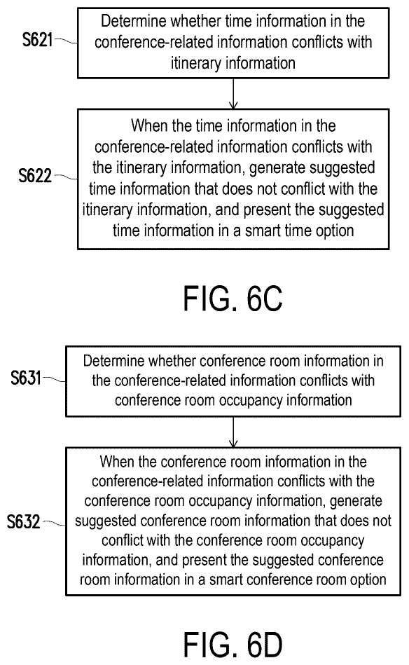

Next, the sensor 140 detects that the relative position between the first display 110 and the second display 120 corresponds to the second usage state US2 as shown in FIG. 4A or FIG. 4B. FIG. 6A is a flowchart of conference arrangement according to an embodiment of the disclosure, and FIG. 6B is a flowchart of auxiliary prompting according to an embodiment of the disclosure. Please refer to FIG. 6A and FIG. 6B. When the relative position corresponds to the second usage state US2, the processor 170 may capture the handwritten information on the first display 110 (step S601 and step S611). For example, the processor 170 converts a handwriting trajectory into a text content, and generates the handwritten information (that is, including the corresponding text content, such as “conference time . . . ”, “location . . . ”, and “members . . . ”) accordingly. In addition, the processor 170 may generate the prompt information according to the second usage state US2 and the handwritten information (step S602 and step S612) to be input into the neural network model. The prompt information corresponds to conference-related information (for example, “conference time . . . ”, “location . . . ”, and “members . . . ”). The neural network model outputs the derivative information. The derivative information indicates an itinerary arrangement and provides corresponding time options.

Next, the processor 170 may add a conference event according to the conference-related information (step S603). The processor 170 displays a prompt inquiring about the itinerary arrangement on the first display 110, such as “what time would you like to schedule a conference on March 20 in your calendar?” In addition, the processor 170 may display an auxiliary function list AFB in a local region of the second display 120 according to the conference-related information (step S613 and step S530). The auxiliary function list AFB corresponds to the derivative information. For example, the processor 170 provides a time option B1 (for example, three times in the morning) and a time option B2 (for example, three times in the afternoon) in an exposed display region of the second display 110. The processor 170 may add the conference event to the calendar program according to the inquiry prompt and the confirmation of the time option B1 or B2. The conference event corresponds to, for example, “conference time . . . ”, “location . . . ”, and “members . . . ” and the selected time option B1 or B2.

FIG. 6C is a flowchart of itinerary conflict management according to an embodiment of the disclosure. Please refer to FIG. 6C. The auxiliary function list may include a smart time option. The processor 170 may determine whether time information in the conference-related information conflicts with itinerary information (step S621). The time information is, for example, “conference time . . . ” corresponding to the handwritten information of FIG. 5B. The itinerary information corresponds to a time period indicated by the existing conference event in the calendar program. The processor 170 may determine whether the times overlap or are too close (for example, within 5 minutes or 10 minutes) as a basis for conflict judgement.

When the time information in the conference-related information conflicts with the itinerary information, the processor 170 may generate suggested time information that does not conflict with the itinerary information, and present the suggested time information in the smart time option (step S622). For example, when the time information overlaps with or is too close to the time corresponding to the itinerary information, the processor 170 uses a time that is longer apart from (for example, 1 hour, 6 hours, or 1 day before/after) the itinerary information as the suggested time information. At this time, the auxiliary function list AFB shown in FIG. 5A presents the suggested time information.

FIG. 6D is a flowchart of occupancy conflict management according to an embodiment of the disclosure. Please refer to FIG. 6D. The auxiliary function list includes a smart conference room option. The processor 170 may determine whether conference room information in the conference-related information conflicts with conference room occupancy information (step S631). The conference room information is, for example, “location . . . ” corresponding to the handwritten information of FIG. 5B. The conference room occupancy information corresponds to identification information of a conference room specified by the conference event that is already present in the calendar program. The processor 170 may determine whether the conference room information and the conference room occupancy information specify the identification information of the same conference room at the same time as a basis for conflict judgement.

When the conference room information in the conference-related information conflicts with the conference room occupancy information, the processor 170 may generate suggested conference room information that does not conflict with the conference room occupancy information, and present the suggested conference room information in the smart conference room option (step S632). For example, when the conference room information and the conference room occupancy information specify the identification information of the same conference room at the same time, the processor 170 selects different identification information (that is, a conference room that is not yet occupied) as the suggested conference room information. At this time, the auxiliary function list AFB shown in FIG. 5A presents the suggested conference room information.

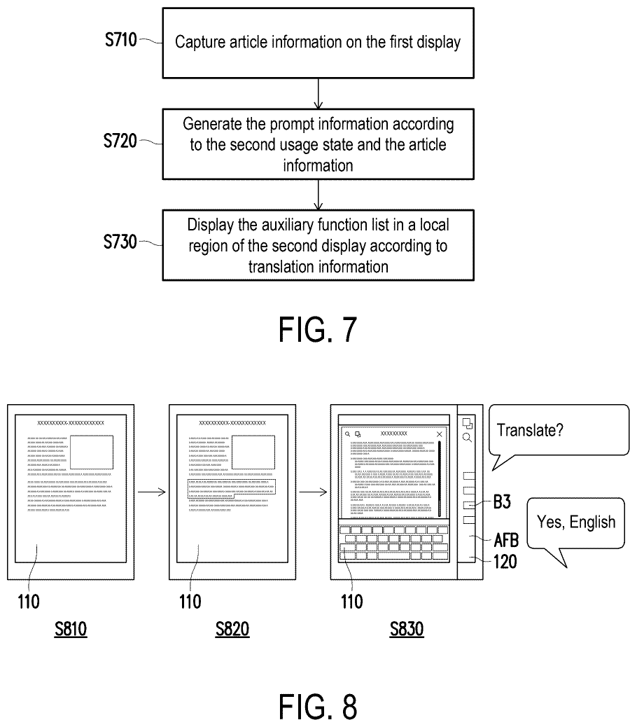

FIG. 7 is a flowchart of translation according to an embodiment of the disclosure, and FIG. 8 is a schematic diagram of a translation scenario according to an embodiment of the disclosure. Please refer to FIG. 7 and FIG. 8. In the first usage state US1 as shown in FIG. 4A or FIG. 4B, the first display 110 presents a document or a book (step S810). The interface may receive the touch operation of the user through the touch panel 150, and receive corresponding selected information accordingly (step S820). A section of a text content is selected as shown in the figure. When the relative position corresponds to the second usage state US2 as shown in FIG. 4A or FIG. 4B, the processor 170 captures article information on the first display 110 (step S710). The article information is, for example, the selected information corresponding to the touch operation or the content of the entire article. In addition, the processor 170 may generate the prompt information according to the second usage state US2 and the article information (step S720) to be input into the neural network model. The prompt information corresponds to text information (for example, the selected information corresponding to the touch operation or the content of the entire article). The neural network model outputs the derivative information. At this time, the derivative information corresponds to translation information of the article information. For example, the touch operation corresponds to the text content of one or more language translations of the selected information or the content of the entire article.

Next, the processor 170 may display the auxiliary function list AFB in a local region of the second display 120 according to the translation information (step S730 and step S830). The auxiliary function list AFB includes a document suggestion option B3, and the document suggestion option B3 is configured to provide the translation information. For example, the processor 170 provides the document suggestion option B3 (for example, options for four languages) in the exposed display region of the second display 110. The processor 170 may present a prompt inquiring about article translation, such as “translate?” The processor 170 may provide the translation information in a corresponding language, such as English translation, according to the inquiry prompt and the confirmation of the document suggestion option B3.

In another embodiment, the derivative information corresponds to document selection information of the article information, such as the text content of one or more related documents of the selected information corresponding to the touch operation or the content of an entire conference record page.

Next, the processor 170 may display the auxiliary function list AFB in a local region of the second display 120 according to the translation information. The auxiliary function list AFB includes the document suggestion option B3. At this time, the document suggestion option B3 is configured to provide the document selection information. For example, the processor 170 provides the document suggestion options B3 (for example, options of four-country documents) in the exposed display region of the second display 110. The processor 170 may present a prompt inquiring about document selection, such as “open related documents?”. The processor 170 may open a corresponding article according to the inquiry prompt and the confirmation of the document suggestion option B3.

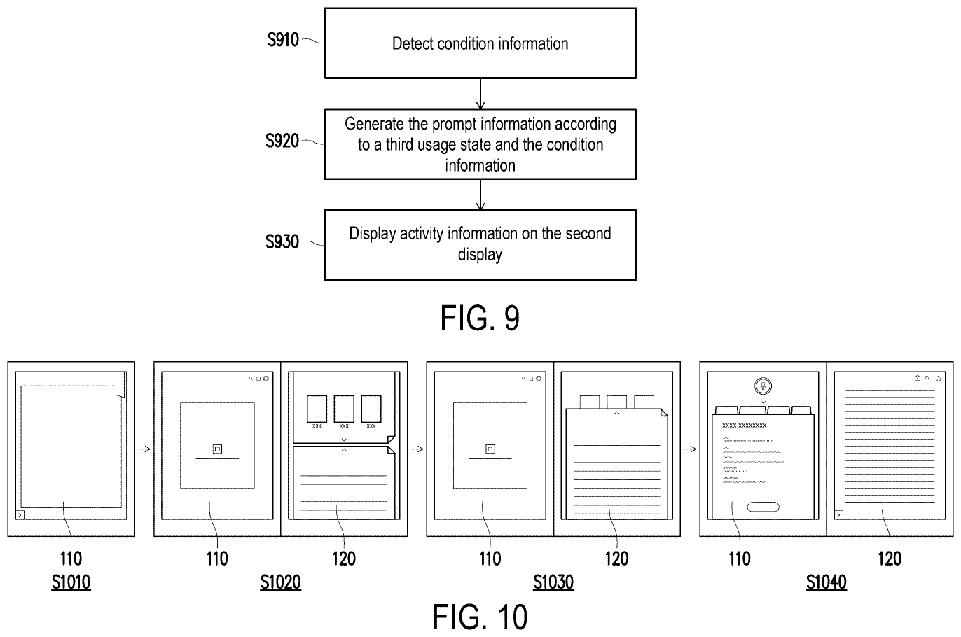

FIG. 9 is a flowchart of activity suggestion according to an embodiment of the disclosure, and FIG. 10 is a schematic diagram of a note-taking scenario according to an embodiment of the disclosure. Please refer to FIG. 9 and FIG. 10. An initial state is the first usage state US1 as shown in FIG. 4A or FIG. 4B (step S1010). When the relative position is detected to correspond to the third usage state US3 as shown in FIG. 4A or FIG. 4B, the processor 170 may detect condition information (step S910 and step S1020). The condition information includes time, location, routine (for example, personal habits), calendar (for example, itinerary arrangement), or a combination thereof. In addition, the processor 170 may generate the prompt information according to the third usage state US3 and the condition information (step S920) to be input into the neural network model. The prompt information corresponds to a content specified by the condition information. The neural network model outputs the derivative information. At this time, the derivative information corresponds to activity information, such as reading conference-related documents or starting conference note-taking. The processor 170 may display the activity information on the second display 120 (step S930). For example, the second display 120 of step S1020 is divided into upper and lower display regions and is configured to present options corresponding to two activity information. The processor 170 may provide the corresponding activity information on the second display 120 according to the option confirmation corresponding to the activity information, such as opening the notebook program and starting conference note-taking (step S1030). Next, a conference note-taking mode is entered, the first display 110 displays conference record organization, and the second display 120 displays notes that may be written during the conference (step S1040).

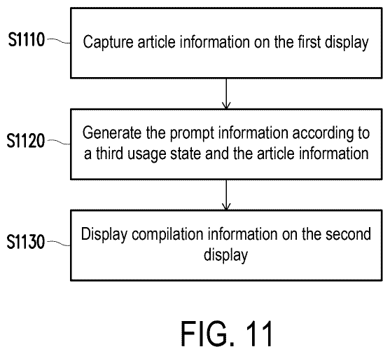

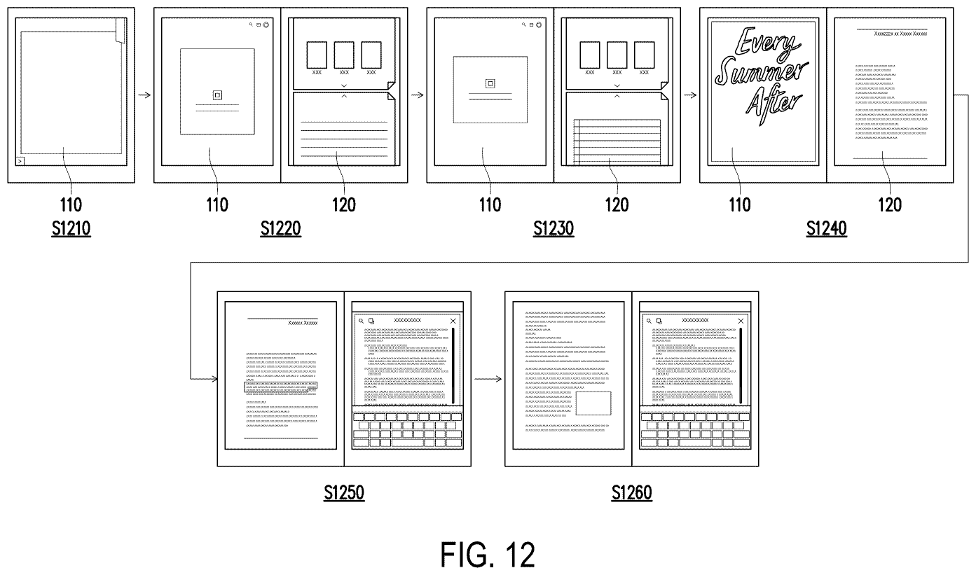

FIG. 11 is a flowchart of article compilation according to an embodiment of the disclosure, and FIG. 12 is a schematic diagram of an article compilation scenario according to an embodiment of the disclosure. Please refer to FIG. 11 and FIG. 12. An initial state is the first usage state US1 as shown in FIG. 4A or FIG. 4B (step S1210). When the relative position is detected to correspond to the third usage state US3 as shown in FIG. 4A or FIG. 4B, the processor 170 may detect the condition information (step S1220). At this time, the condition information includes time and calendar, such as conference(s) scheduled to take place within 1 hour. In addition, the processor 170 may generate the prompt information according to the third usage state US3 and the condition information to be input into the neural network model. The prompt information corresponds to the content specified by the condition information. The neural network model outputs the derivative information. At this time, the derivative information corresponds to the activity information, such as reading conference-related documents or starting conference note-taking. The processor 170 may display the activity information on the second display 120. For example, the second display 120 of step S1220 is divided into upper and lower display regions and is configured to present the options corresponding to the two activity information. The processor 170 may provide the corresponding activity information on the second display 120 according to the option confirmation corresponding to the activity information, such as the option of reading conference-related documents being selected (step S1230). Next, a dual-screen reading mode is entered, and the processor 170 starts a document browsing program and opens conference-related documents. The first display 110 and the second display 120 display the documents (step S1240).

In addition, when the relative position corresponds to the third usage state US3 as shown in FIG. 4A or FIG. 4B, the processor 170 may capture the article information on the first display 110 (step S1110 and step S1220). The article information is, for example, the text content in the document displayed in step S1240. In addition, the processor 170 may generate the prompt information according to the third usage state US3 and the article information (step S1120) to be input into the neural network model. The prompt information corresponds to the text content of the article information. The neural network model outputs the derivative information. At this time, the derivative information corresponds to compilation information of the article information. The processor 170 may display the compilation information, such as the summary of the document displayed in step S1240, on the second display 120 (step S1130 and step S1250). In some embodiments, the second display 120 may display summaries of multiple pages of the document in a list. In addition, when the touch panel 150 receives the user operation corresponding to the summary of a certain page, the processor 170 may display the page or related paragraphs thereof on the second display 120 (step S1260).

In another embodiment, the processor 170 may detect the condition information (step S1220). At this time, the condition information includes the routine habits of the user, such as an activity content of using the apparatus in a room at home at 10 p.m. At this time, the first display 110 may display books that are frequently read during this period and may be continued to be read. When the relative position is detected to be the third usage state US3 as shown in FIG. 4A or FIG. 4B, the processor 170 may generate the prompt information according to the third usage state US3 and the condition information to be input into the neural network model. The prompt information corresponds to the content specified by the condition information. The neural network model outputs the derivative information. At this time, the derivative information corresponds to the activity information, such as continuing to read a book or checking the calendar for tomorrow. The processor 170 may display the activity information on the second display 120. For example, the second display 120 of step S1220 is divided into upper and lower display regions and is configured to present the options corresponding to the two activity information. The processor 170 may provide the corresponding activity information on the second display 120 according to the option confirmation corresponding to the activity information, such as the option of continuing to read a book being selected (step S1230). Next, the dual-screen reading mode is entered, and the processor 170 starts the document browsing program, and opens book-related documents. The first display 110 and the second display 120 display the file (step S1240).

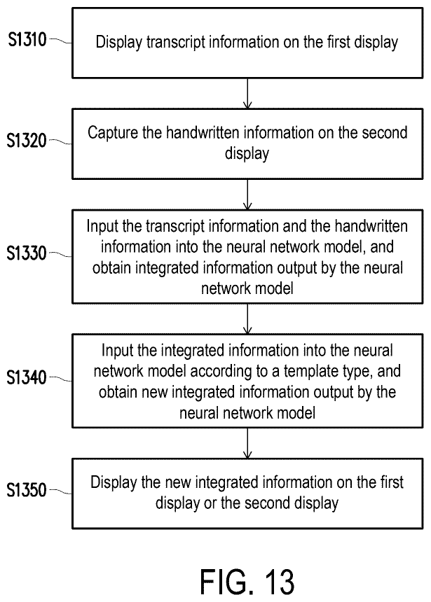

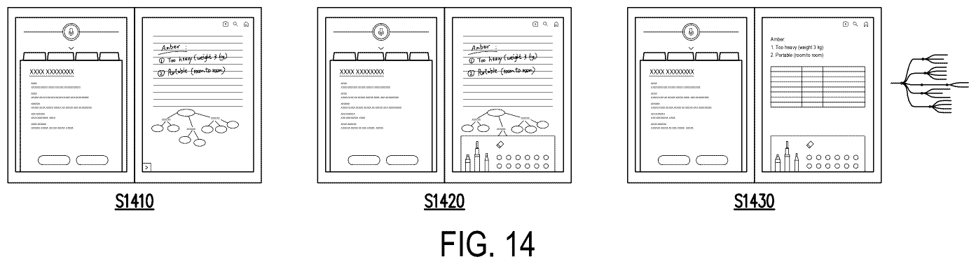

FIG. 13 is a flowchart of information integration according to an embodiment of the disclosure, and FIG. 14 is a schematic diagram of an information integration scenario according to an embodiment of the disclosure. Please refer to FIG. 13 and FIG. 14. The processor 170 may display transcript information on the first display 110 (step S1310 and step S1410). For example, a voice signal is obtained and converted into an analyzable digital signal, spectrum information, pitch, or other sound features are captured from the digital signal, the sound of words is recognized and possible words are predicted according to the sound features using a statistical model, and prediction results of acoustics and language models are combined to generate the final transcript information. In addition, the processor 170 displays the notebook program on the second display 120, and receives the handwritten information through the touch panel 150 (step S1420). The processor 170 may capture the handwritten information on the second display 120 (step S1320 and step S1420). For example, the user writes down the conference record and a tree diagram.

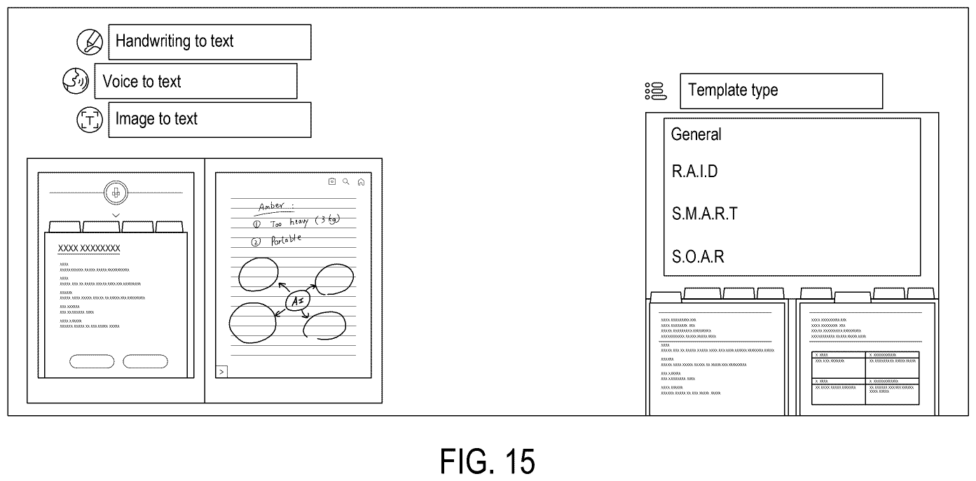

The processor 170 may input the transcript information and the handwritten information into the neural network model, and obtain integrated information output by the neural network model (step S1330), such as a content that integrates the text contents of the transcript information and the handwritten information. Next, the processor 170 may input the integrated information into the neural network model according to a template type, and obtain new integrated information output by the neural network model (step S1340). FIG. 15 is a schematic diagram of input conversion and template application according to an embodiment of the disclosure. Please refer to FIG. 15. The template type is, for example, general, risks, assumptions, issues, and dependencies (R.A.I.D), specific, measurable, attainable, relevant, and time-bound (S.M.A.R.T), or strengths, opportunities, aspirations, and results (S.O.A.R). At this time, the new integrated information is in a format of mapping the integrated information to the selected template type.

In addition to voice input (corresponding to the transcript information) and handwritten input (corresponding to the handwritten information), in some embodiments, a photo input form (corresponding to an input image) is also provided and serves as the prompt information input into the neural network model.

Next, the processor 170 may display the new integrated information on the first display 110 or the second display 120 (step S1350). For example, the second display 120 displays a conference highlight, a digital table, and a mind map (step S1430). The new integrated information may be further shared with other apparatuses, and the other apparatuses may edit the new integrated information.

In summary, in the dual-screen mobile apparatus and the control method for the dual-screen mobile apparatus according to the embodiments of the disclosure, the first display and the second display are provided and may be slidably expanded relative to each other. In the embodiments of the disclosure, different artificial intelligence (AI) auxiliary functions may be provided according to the expanded state of the first display and the second display. The user may write freely on the first display, the system detects the writing content of the user and provide a variety of AI information organization and itinerary arrangements, and the AI assistant retrieves appropriate files in the apparatus as required for the reference of the user. In the embodiments of the disclosure, the intention of the user may be actively detected through AI, and activity suggestions suitable for the user at the moment may be provided. In the embodiments of the disclosure, activities may be recommended according to the condition information, such as current location, time, frequently used tools, and personal calendar login data, of the user. In the embodiments of the disclosure, sufficient suggestion information may be presented for display sizes of different expanded/closed screens. The use of the dual screens not only meets the requirement of browsing and editing the original text, but also meets the requirement of presenting the generated AI application.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. A dual-screen mobile apparatus, comprising:
a first body;
a first display, disposed on the first body;
a second body;
a second display, disposed on the second body, wherein a normal direction of a panel of the second display is the same as a normal direction of a panel of the first display;
a movable mechanism, movably connecting the first body and the second body and configured to translate and slide at least one of the first body and the second body;
at least one sensor, disposed on at least one of the first body and the second body and configured to detect a relative position between the first display and the second display; and
a processor, coupled to the first display, the second display, and the at least one sensor and configured to:
generate prompt information according to the relative position between the first display and the second display and a display content of the first display; and
input the prompt information into a neural network model, and obtain derivative information corresponding to the prompt information output by the neural network model; and
generate a display content of the second display according to the derivative information.

2. The dual-screen mobile apparatus according to claim 1, wherein the at least one sensor comprises a first switch and a second switch, and the processor is further configured to:
when the first switch and the second switch are both triggered, determine that the relative position corresponds to a first usage state, and completely cover the panel of the second display by the first body;
when one of the first switch and the second switch is triggered but other one of the first switch and the second switch is not triggered, determine that the relative position corresponds to a second usage state, and partially cover the panel of the second display by the first body; and
when the first switch and the second switch are both not triggered, determine that the relative position corresponds to a third usage state, and completely not cover the panel of the second display by the first body.

3. The dual-screen mobile apparatus according to claim 1, wherein the at least one sensor comprises a distance sensor, and the processor is further configured to:
when the distance sensor detects first distance information, determine that the relative position corresponds to a first usage state, and completely cover the panel of the second display by the first body;
when the distance sensor detects second distance information, determine that the relative position corresponds to a second usage state, and partially cover the panel of the second display by the first body, wherein a distance value indicated by the second distance information is greater than a distance value indicated by the first distance information; and
when the distance sensor detects third distance information, determine that the relative position corresponds to a third usage state, and completely not cover the panel of the second display by the first body, wherein a distance value indicated by the third distance information is greater than the distance value indicated by the second distance information.

4. The dual-screen mobile apparatus according to claim 1, further comprising:
a touch panel, disposed on the first display and configured to receive handwritten information, wherein the processor is further configured to:
when the relative position corresponds to a second usage state, capture the handwritten information on the first display, and generate the prompt information according to the second usage state and the handwritten information, wherein the prompt information corresponds to conference-related information; and
add a conference event according to the conference-related information.

5. The dual-screen mobile apparatus according to claim 1, further comprising:
a touch panel, disposed on the first display and configured to receive handwritten information, wherein the processor is further configured to:
when the relative position corresponds to a second usage state, capture the handwritten information on the first display, and generate the prompt information according to the second usage state and the handwritten information, wherein the prompt information corresponds to conference-related information; and
display an auxiliary function list in a local region of the second display according to the conference-related information, wherein the auxiliary function list corresponds to the derivative information.

6. The dual-screen mobile apparatus according to claim 5, wherein the auxiliary function list comprises a smart time option, and the processor is further configured to:
determine whether time information in the conference-related information conflicts with itinerary information; and
when the time information in the conference-related information conflicts with the itinerary information, generate suggested time information that does not conflict with the itinerary information, and present the suggested time information in the smart time option.

7. The dual-screen mobile apparatus according to claim 5, wherein the auxiliary function list comprises a smart conference room option, and the processor is further configured to:
determine whether conference room information in the conference-related information conflicts with conference room occupancy information; and
when the conference room information in the conference-related information conflicts with the conference room occupancy information, generate suggested conference room information that does not conflict with the conference room occupancy information, and present the suggested conference room information in the smart conference room option.

8. The dual-screen mobile apparatus according to claim 1, wherein the processor is further configured to:
when the relative position corresponds to a second usage state, capture article information on the first display, and generate the prompt information according to the second usage state and the article information, wherein the derivative information corresponds to translation information of the article information; and
display an auxiliary function list in a local region of the second display according to the translation information, wherein the auxiliary function list comprises a document suggestion option, and the document suggestion option is configured to provide the translation information.

9. The dual-screen mobile apparatus according to claim 1, wherein the processor is further configured to:
when the relative position corresponds to a third usage state, capture article information on the first display, and generate the prompt information according to the third usage state and the article information, wherein the derivative information corresponds to compilation information of the article information; and
display the compilation information on the second display.

10. The dual-screen mobile apparatus according to claim 1, wherein the processor is further configured to:
when the relative position corresponds to a third usage state, detect condition information, and generate the prompt information according to the third usage state and the condition information, wherein the derivative information corresponds to activity information, and the condition information comprises time, location, routine, calendar, or a combination thereof; and
display the activity information on the second display.

11. The dual-screen mobile apparatus according to claim 1, further comprising:
a touch panel, disposed on the second display and configured to receive handwritten information, wherein the processor is further configured to:
display transcript information on the first display;
capture the handwritten information on the second display;
input the transcript information and the handwritten information into the neural network model, and obtain integrated information output by the neural network model;
input the integrated information into the neural network model according to a template type, and obtain new integrated information output by the neural network model; and
display the new integrated information on the first display or the second display.

12. A control method for a dual-screen mobile apparatus, comprising:
providing a first display, a second display, a movable mechanism, at least one sensor, and a processor, wherein the first display is disposed on a first body, the second display is disposed on a second body, a normal direction of a panel of the second display is the same as a normal direction of a panel of the first display, the movable mechanism movably connects the first body and the second body and is configured to translate and slide at least one of the first body and the second body, and the at least one sensor is configured to detect a relative position between the first display and the second display;
generating prompt information according to the relative position between the first display and the second display and a display content of the first display; and
inputting the prompt information into a neural network model, and obtaining derivative information corresponding to the prompt information output by the neural network model; and
generating a display content of the second display according to the derivative information.

13. The control method for the dual-screen mobile apparatus according to claim 12, wherein the at least one sensor comprises a first switch and a second switch, and the control method further comprises:
when the first switch and the second switch are both triggered, determining that the relative position corresponds to a first usage state, and completely covering the panel of the second display by the first body;
when one of the first switch and the second switch is triggered but other one of the first switch and the second switch is not triggered, determining that the relative position corresponds to a second usage state, and partially covering the panel of the second display by the first body; and
when the first switch and the second switch are both not triggered, determining that the relative position corresponds to a third usage state, and completely not covering the panel of the second display by the first body.

14. The control method for the dual-screen mobile apparatus according to claim 12, wherein the at least one sensor comprises a distance sensor, and the control method further comprises:
when the distance sensor detects first distance information, determining that the relative position corresponds to a first usage state, and completely covering the panel of the second display by the first body;
when the distance sensor detects second distance information, determining that the relative position corresponds to a second usage state, and partially covering the panel of the second display by the first body, wherein a distance value indicated by the second distance information is greater than a distance value indicated by the first distance information; and
when the distance sensor detects third distance information, determining that the relative position corresponds to a third usage state, and completely not covering the panel of the second display by the first body, wherein a distance value indicated by the third distance information is greater than the distance value indicated by the second distance information.

15. The control method for the dual-screen mobile apparatus according to claim 12, further comprising:
providing a touch panel, wherein the touch panel is disposed on the first display and is configured to receive handwritten information;
when the relative position corresponds to a second usage state, capturing the handwritten information on the first display, and generating the prompt information according to the second usage state and the handwritten information, wherein the prompt information corresponds to conference-related information; and
adding a conference event according to the conference-related information.

16. The control method for the dual-screen mobile apparatus according to claim 12, further comprising:
providing a touch panel, wherein the touch panel is disposed on the first display and is configured to receive handwritten information;
when the relative position corresponds to a second usage state, capturing the handwritten information on the first display, and generating the prompt information according to the second usage state and the handwritten information, wherein the prompt information corresponds to conference-related information; and
displaying an auxiliary function list in a local region of the second display according to the conference-related information, wherein the auxiliary function list corresponds to the derivative information.

17. The control method for the dual-screen mobile apparatus according to claim 16, wherein the auxiliary function list comprises a smart time option, and the control method further comprises:
determining whether time information in the conference-related information conflicts with itinerary information; and
when the time information in the conference-related information conflicts with the itinerary information, generating suggested time information that does not conflict with the itinerary information, and presenting the suggested time information in the smart time option.

18. The control method for the dual-screen mobile apparatus according to claim 16, wherein the auxiliary function list comprises a smart conference room option, and the control method further comprises:
determining whether conference room information in the conference-related information conflicts with conference room occupancy information; and
when the conference room information in the conference-related information conflicts with the conference room occupancy information, generating suggested conference room information that does not conflict with the conference room occupancy information, and presenting the suggested conference room information in the smart conference room option.

19. The control method for the dual-screen mobile apparatus according to claim 12, further comprising:
when the relative position corresponds to a second usage state, capturing article information on the first display, and generating the prompt information according to the second usage state and the article information, wherein the derivative information corresponds to translation information of the article information; and
displaying an auxiliary function list in a local region of the second display according to the translation information, wherein the auxiliary function list comprises a document suggestion option, and the document suggestion option is configured to provide the translation information.

20. The control method for the dual-screen mobile apparatus according to claim 12, further comprising:
when the relative position corresponds to a third usage state, capturing article information on the first display, and generating the prompt information according to the third usage state and the article information, wherein the derivative information corresponds to compilation information of the article information; and
displaying the compilation information on the second display.

21. The control method for the dual-screen mobile apparatus according to claim 12, further comprising:
when the relative position corresponds to a third usage state, detecting condition information, and generating the prompt information according to the third usage state and the condition information, wherein the derivative information corresponds to activity information, and the condition information comprises time, location, routine, calendar, or a combination thereof; and
displaying the activity information on the second display.

22. The control method for the dual-screen mobile apparatus according to claim 12, further comprising:
providing a touch panel, wherein the touch panel is disposed on the second display and is configured to receive handwritten information;
displaying transcript information on the first display;
capturing the handwritten information on the second display;
inputting the transcript information and the handwritten information into the neural network model, and obtaining integrated information output by the neural network model;
inputting the integrated information into the neural network model according to a template type, and obtaining new integrated information output by the neural network model; and
displaying the new integrated information on the first display or the second display.
